(19) United States
(12) Patent Application Publication
(10) Pub. No.: US 2006/0166856 A1
(43) Pub. Date: Jul. 27, 2006

(54) Fragrance composition comprising at least one ionic liquid, method for production and use thereof

(75) Inventors: Frank-Martin Petrat, Munster (DE); Friedrich Georg Schmidt, Haltern am See (DE); Bernhard Stutzel, Marl (DE); Gunther Kohler, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Dusseldorf (DE)

(21) Appl. No.: 10/529,947

(22) PCT Filed: Oct. 8, 2003
(86) PCT No.: PCT/EP03/11110

§ 371 Date: Oct. 4, 2005

(30) Foreign Application Priority Data
Oct. 11, 2002 (DE) 102 47 514.8
Aug. 16, 2003 (DE) 103 37 579.1

(51) Int. Cl. A61Q 13/00

(52) U.S. Cl. 512/2

(57) ABSTRACT

The invention relates to a fragrance composition which has, as fixative, at least one ionic liquid, and to the preparation and use thereof. The fragrance compositions according to the invention are advantageous since the ionic liquid, being a polar solvent which has as it were no vapor pressure, can delay the evaporation of the base scent components in a targeted manner. The large choice of ionic liquids allows the rate of evaporation of the scent components to be adjusted precisely. Since the polarity of the ionic liquids can be varied by means of the structure of the cations and/or anions within wide ranges, the ionic liquids used as fixative can be matched precisely to the chemicophysical and/or olfactory requirements of the scent component.

The present invention relates to a fragrance composition which has at least one ionic liquid as fixative, and to the preparation and use thereof.

In the manufacture of fragrances, fixatives is the term used for substances which are able to impart increased stability to the scent of—in perfumes free, in soaps bound—fragrances and to slow and match the evaporation of the individual scent components such that the scent character during the evaporation time remains reasonably constant. The substances used as fixatives are mostly difficultly volatile and high-boiling and may themselves be scented or unscented. A distinction is made between four main groups of fixatives. Self-fixatives which, due to their low volatility, retain their intrinsic odor for a long time without, in so doing, hindering other more readily volatile components from developing their odor (synthetic musk entities); pseudofixatives, as weakly odorous, viscous to crystalline substances which act as stabilizers or as diffusion agents (diethylene glycol methyl ether); stimulants, natural animalic fixatives acting as “catalysts” of scent development, and basic substances or synthetic analogs thereof (ambergris, castoreum, musk, civet, muscone, some macrolides, Fixative 404 etc.); “true” fixatives, fixatives fixing by forces of adsorption (extracts of labdanum, styrax, tolu balsam, benzoin, iris, oak moss, opopanax etc.). The effect of the fixatives, often also called bases, is based on a reduction in the vapor pressure of the fragrances, e.g. by dipole formation, hydrogen bridge bonding, adsorption effects, formation of azeotropic mixtures, although a number of other, including skin physiological, effects also make their influence felt. (Römpp Lexikon Chemie—Version 2.0, Stuttgart/New York: Georg Thieme Verlag 1999)

Since ever new scent variations are being created and thus ever new artificial aromas or scent components are being used, there is the need to find ever new substances which are suitable as fixatives for the particular scent components or scent component compositions. The number of compounds suitable as fixatives can scarcely keep up with the rapidly growing number of scent components and scent or fragrance compositions.

It was therefore the object to provide a fixative which controls in a targeted manner the evaporation and/or release of scent or fragrance components from fragrance compositions and which should be variable such that it can be adapted to the various requirements of the scents and/or fragrances used, in particular newly created scents and fragrances, in a simple manner.

Surprisingly, it has been found that ionic liquids are exceptionally suitable as fixatives in fragrance compositions since they have virtually no vapor pressure and, depending on the structure of the cations and/or anions used, are readily adjustable in their polarity within wide ranges and can thus be adapted to the particular fragrance.

The present invention therefore provides a fragrance composition which has a fixative which is notable for the fact that the fragrance composition has at least one ionic liquid as fixative.

The present invention likewise provides a method of preparing fragrance compositions according to the invention which comprises intensively mixing a fragrance component with an ionic liquid.

Furthermore, the present invention provides the use of fragrance compositions according to the invention in various products of daily need, such as, for example, fine perfumes, bodycare compositions, toiletries, such as, for example, soaps, deodorants and many more, detergent perfumes, fabric softener perfumes or perfumes for masking industrial odors and for their preparation, and also products of daily need which have the fragrance compositions according to the invention.

The fragrance compositions according to the invention have the advantage that they can be produced in a simple manner. In particular, the fixatives can be matched in a simple way to the fragrance or scent components used. The use of ionic liquids also has the advantage that ionic fluids are of relatively low viscosity despite the very low vapor pressure. In the case of conventional compounds used as fixative, such as, for example, diethylene glycol methyl ether, a low vapor pressure is in most cases associated with a high viscosity, as a result of which the processibility of such compositions is impaired and/or dilution is rendered necessary.

The present invention is described below by way of example without intending to limit the invention to this.

The fragrance composition according to the invention which has a fixative is notable for the fact that it has at least one ionic liquid as fixative. Preferably, the fragrance composition has from 0.1% by weight to 20% by weight of ionic liquid, particularly preferably from 0.5% by weight to 10% by weight of ionic liquid and very particularly preferably from 1 to 5% by weight of ionic liquid, based on the base oil.

For fragrance compositions, the following classifications are customary in perfumery: 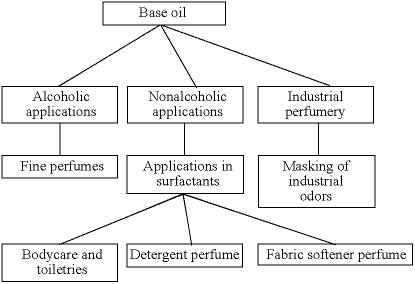
where base oil should be understood as meaning the actual scents or perfume oils.

In general, an ionic liquid is understood as meaning a liquid which consists exclusively of ions. In differentiation to the classical term of salt melt, which is usually a high-melting, high-viscosity and in most cases very corrosive medium, ionic liquids are liquid and of relatively low viscosity even at low temperatures (<100° C.). Although ionic liquids have been known since 1914, they have only been investigated intensively in the last 10 years as solvents and/or catalyst in organic syntheses (review article by K. R. Seddon in J. Chem. Technol. Biotechnol. 68 (1997), 351-356; T. Welton, in Chem. Rev. 99 (1999), 2071-2083; J. D. Holbrey, K. R. Seddon in Clean Products and Processes 1 (1999) 223-236; P. Wasserscheid, W. Keim in Angew. Chem. 112 (2000), 3926-3945 and R. Sheldon in Chem. Comm. (2001), 2399-2407). Preferred ionic liquids have a melting point of less than 80° C. Very particularly preferred ionic liquids are present in the liquid phase at room temperature.

As ionic liquid, the fragrance composition preferably has at least one salt with a cation according to the following structures 1 to 8, 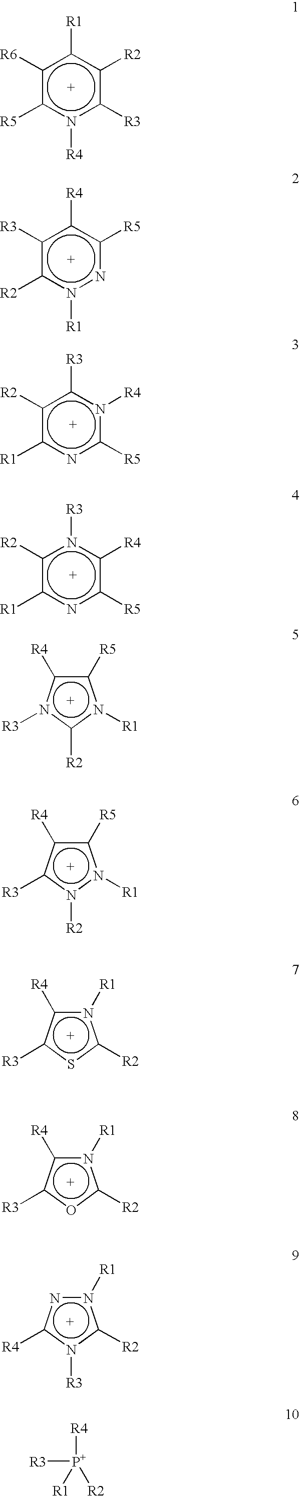 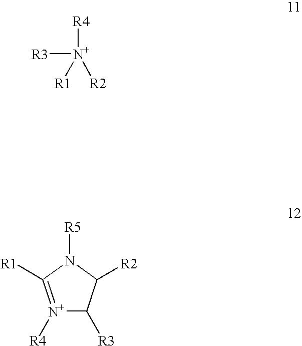
where R1, R2, R3, R4, R5 and R6 are identical or different and are hydrogen, a linear or branched aliphatic hydrocarbon radical having 1 to 20 carbon atoms, a cycloaliphatic hydrocarbon radical having 5 to 30 carbon atoms, an aromatic hydrocarbon radical having 6 to 30 carbon atoms, an alkylaryl radical having 7 to 40 carbon atoms, a linear or branched aliphatic hydrocarbon radical having 2 to 20 carbon atoms which is interrupted by one or more heteroatoms (oxygen, NH, NCH₃), a linear or branched aliphatic hydrocarbon radical having 2 to 20 carbon atoms which is interrupted by one or more functionalities chosen from the group —O—C(O)—, —(O)C—O—, —NH—C(O)—, —(O)C—NH, —(CH₃)N—C(O)—, —(O)C—N(CH₃)—, —S(O)₂—O—, —O—S(O)₂—, —S(O)₂—NH—, —NH—S(O)₂—, —S(O)₂—N(CH₃)—, —N(CH₃)—S(O)₂—, a terminally —OH, —NH₂, —N(H)CH₃ functionalized linear or branched aliphatic hydrocarbon radical having 1 to 20 carbon atoms or a polyether with a blockwise or random structure according to —(R⁷—O)—R⁸, where R⁷ is a linear or branched hydrocarbon radical containing 2 to 4 carbon atoms, n =1 to 30 and R⁸ is hydrogen, a linear or branched aliphatic hydrocarbon radical having 1 to 20 carbon atoms, a cycloaliphatic hydrocarbon radical having 5 to 30 carbon atoms, an aromatic hydrocarbon radical having 6 to 30 carbon atoms, an alkylaryl radical having 7 to 40 carbon atoms, or are a radical —C(O)—R⁹ where R⁹ is a linear or branched aliphatic hydrocarbon radical having 1 to 20 carbon atoms, a cycloaliphatic hydrocarbon radical having 5 to 30 carbon atoms, an aromatic hydrocarbon radical having 6 to 30 carbon atoms, an alkylaryl radical having 7 to 40 carbon atoms; and an anion chosen from the group consisting of halide, i.e. chloride, bromide or iodide, preferably iodide; phosphate, halophosphates, preferably hexafluorophosphate; alkylphosphates, nitrate, sulfate, hydrogensulfate, alkylsulfates, preferably octylsulfate; arylsulfates, perfluorinated alkyl- and arylsulfates, sulfonate, alkylsulfonates, arylsulfonates, perfluorinated alkyl- and arylsulfonates, preferably triflate; perchlorate, tetrachloroaluminate, tetrafluoroborate, alkylborates, preferably B(C₂H₅)₃C₆H₁₃—; tosylate, saccharinate, alkylcarboxylates and bis(perfluoroalkylsulfonyl)amide anions preferably the bis(trifluoromethylsulfonyl)amide ion; or is a mixture of two or more such salts.

In a preferred embodiment of the fragrance composition according to the invention, the ionic liquid has halogen-free anions chosen from the group consisting of phosphate, alkylphosphates, nitrate, sulfate, alkylsulfates, arylsulfates, sulfonate, alkylsulfonates, arylsulfonates, alkylborates, tosylate, saccharinate and alkylcarboxylates, particular preference being given to alkylsulfates, in particular octylsulfate, and tosylate.

As ionic liquid, the fragrance composition particularly preferably has at least one salt with a cation chosen from the group consisting of imidazolium ion, pyridinium ion, ammonium ion or phosphonium ion according to the following structures: 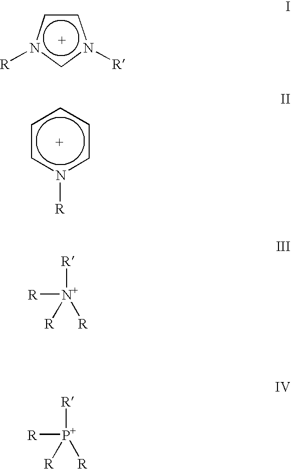
where R and R′═H, identical or different substituted or unsubstituted alkyl, olefin or aryl groups with the proviso that R and R′ have identical or different meanings.

Particularly preferred ionic liquids are, for example, 1-ethyl-3-methylimidazolium tosylate, trioctylammonium octylsulfate, 1,3-dimethylimidazolium octylsulfate, 1-ethyl-3-methylimidazoliumbis(trifluoromethylsulfonyl)amide, 1-methyl-2-nortallow-3-tallowamidoethylimidazolium methylsulfate or 1-methyl-2-noroleyl-3-oleylamidoethylimidazolium methylsulfate.

It may be advantageous if the fragrance composition has an ionic liquid which has one or more of the abovementioned salts. Here, both the cations and also the anions may be different. The ionic liquid of the fragrance composition particularly preferably has different anions. By using different anions and/or cations, the properties can be matched in an optimal way to the other components of the fragrance composition, in particular to the scent components.

The preparation of the ionic liquid is generally known and can take place, for example, as described in the literature, inter alia in S. Saba, A. Brescia, M. Kaloustian, Tetrahedron Letters 32(38) (1991), 5031-5034, EP 1 072 654 and EP 1 178 106. In addition, ionic liquids are also available commercially. Thus, for example, 1,3-dimethylimidazolium methylsulfate, 1-butyl-3-methylimidazolium methylsulfate, 1-ethyl-3-methylimidazolium tosylate, 1-ethyl-2,3-dimethylimidazolium tosylat, and ECOENG™, a halogen-free salt, can be obtained from Solvent Innovation GmbH, Alarichstr. 14-16, 50679 Cologne, Germany.

Depending on the intended use of the fragrance composition, the ionic liquids, like all of the other constituents, have to be chosen so as to exclude an adverse effect in terms of health or ecology on people, nature and the environment. Thus, fragrance compositions which come into direct contact with the human organism, such as, for example, perfumes or food aroma compositions, must have no toxic effect at all, while the requirements on fragrance compositions for which there is no risk at all of a human or animal organism coming into direct contact with it, such as, for example, in the case of room deodorants, may be lesser.

For a number of selected applications, however, it may be advantageous if, in the fragrance composition, compounds, in particular ionic liquids, which have microbicidal properties are present. Such compounds with microbicidal properties are always desirable if a fragrance composition is used for suppressing odors which are formed by microorganisms since by killing the microorganisms, the new formation of the undesired odors can be prevented or at least slowed. Applications are, for example, deodorants or foot sprays.

Besides the ionic liquids, the fragrance compositions according to the invention can have further fixatives chosen from the known self-fixatives, pseudofixatives, stimulants and/or “true” fixatives.

The fragrance composition can additionally have a matrix material. This matrix material may be solid or liquid. Suitable liquid matrix materials are, for example, organic solvents, such as, for example, alcohols or ethers, or water or mixtures thereof. For perfume applications in particular, the fragrance compositions can have alcohol, in particular high-purity ethanol, as liquid matrix material (solvent). Solid matrix materials may, for example, be solid salts, such as, for example, sodium chloride, sodium sulfate, builders, such as, for example, citrate or polycarboxylates, soaps, polymers, such as, for example, cellulose, sheet silicates, such as, for example, bentonites, montmorillonites or organically modified sheet silicates (so-called organo sheet silicates), zeolites, or cyclodextrins. These are always required if the fragrance composition is to be applied in the form of a solid or if fragrance is to be released only upon contact with water.

The fragrance composition according to the invention can have one of the usual, known and customary compounds as aroma, fragrance, fragrance component or scent component. In particular, the fragrance composition can have, as fragrance or aroma, a natural, nature-identical, semisynthetic and/or completely synthetic fragrance or aroma. Such ingredients are sufficiently known. A review of compounds which can be used as fragrance and/or aroma, and background information is given, for example, in Flavor and Fragrance Materials, Worldwide Ref. List (14th), Wheaton: Allured 1987; Frosch et al. (ed.), Fragrances: Beneficial and Adverse Effects, Berlin: Springer 1997; Hager (5th) 1, 152, 198 ff.; Kirk-Othmer (4th) 18, 171-201; Römpp Lexikon Naturstoffe [Römpp Lexicon of Natural Substances], p. 552 f., Ullmann (4th) 20, 199-287; (5th) A 11, 141-250, Vollmer and Franz, Chemie in Bad u. Küche [Chemistry in the Bathroom and Kitchen], pp. 128-140, Stuttgart: Thieme 1991, Calkin and Jellinek, Perfumery—Practice and Principles, New York: Wiley 1994; Kirk-Othmer (4th) 17, 594-603; 18, 171-201; Ullmann (4th) 17, 645-650; 20, 199-287; (5th) A 11, 141-250; Umbach (ed.), Kosmetik [Cosmetics], 2nd edition, pp. 343-360, 408-417, Stuttgart: Thieme 1995; Vollmer and Franz, Chemische Produkte im Alltag [Everyday Chemical Products], pp. 129-142, 433-449, Stuttgart: Thieme 1985.

An overview of the various fragrances, perfumes, scents, fixatives and aromas is given under these keywords in Römpp Lexikon Chemie—Version 2.0, Stuttgart/New York: Georg Thieme Verlag 1999. This also gives a break-down of the typical formulation of a perfume composition (i.e. of a fragrance composition) which, if it has ionic liquids as fixative, likewise falls under the subject-matter of the present invention. The structure of a perfume composition is broken down into:
1. top note (head, peak, initial odor), readily volatile fragrances of mostly fresh character;
2. middle note (bouquet, body, heart, heart note), moderately volatile fragrances of often floral character;
3. base note (foundation, aftersmell), fragrances of low volatility which determine the basic character (lead odor) of the perfume.

Assigned to the base note are also usually the fixatives which increase the binding and the adhesion of the volatile fragrances and stabilize the scent composition. Using adjuvants, top, middle and base notes can be connected together more closely and the scent progression be configured more fluently.

The compounds or mixtures present in the fragrance compositions besides the ionic liquids as scents can include, for example, the following compounds or products from Haarmann and Reimer.

Abriceine, acetanisole dist., acetanisole cryst., acetophenone pure, Agarwood D50092NS, agrumen aldehyde 6947L, Agrumex HC, Agrumex LC, Agrumovert 10897 C/J, aldehyde C 6 nat., aldehyde C11MOA, aldehyde C12 MNA, aldehyde C14 so-called, aldehyde C16 so-called, aldehyde C18 so-called/abricolin, alcohol C 6 nat., alcohol C 8, alcohol C 9, alcohol C10, alcohol C12, Allinat/allyl isothiocyanate, Allinat/allyl isothiocyanate (stab.), allyl capronate, allyl capronate kosher, allyl cyclohexylpropionate, allyl heptylate, allyl phenoxyacetate, Amarocit®, ambre 83LN DB10028, ambrebois D50407, ambrettia C, ambrettolide, ambrinol S, ambroxide cryst., Ananas Coeur D50214, anethole NPU 21/22° C., anethole supra 21.5° C., anisaldehyde pure, anisalcohol, anisole, anisyl acetate, apple 74180C PM, apriconia 28855P extra PM, baldrian identoil B, basil synthessence, bay identoil, benzalacetone, benzaldehyde, benzaldehyde dd, benzophenone cryst., benzyl acetate, benzylacetone, benzyl alcohol dd, benzyl alcohol FR, benzyl benzoate H&R, benzyl benzoate M, benzyl cinnamate, benzyl formate, benzyl propionate, benzyl salicylate, bergamot identoil colorless, bergamot synthessence African, blackberry D50260E, Bois de Cachemire D50008, Bois Doux 78008SP PM, boisanol, boronal, butyric acid nat., butyl butyrate, cocoa and chocolate D50546B, cajeput identoil, calmus synthessence aserone-free, cananga identoil, capric acid nat., caproic acid nat., caramel acetate, cardamom R identoil, cardamom synthessence, cassia identoil, cassia identoil B dark, cassis D50060B, cedar leaves identoil, chloroacetophenone para, chrysanthemum, cinnamyl acetate, citral extra, citron R, citron synthessence FF, citronella identoil, citronell identoil, citronellyl tiglate, citronitrile, Citrowanil® B, citrozone D50620B, citrylal, citrylal E, clarifruit D50757, clarion base D50774, Corapan TQ®, coriander identoil, corps 1729, corps 98N DB10025, corps Racine VS, costus synthessence, coumarone, cumin synthessence, Cyprus identoil, datilat, decalactone gamma nat., decalyl acetate beta, diacetyl nat., dibenzosuberone, dibenzyl ether, diethyl phthalate (DEP), dihydrocoumarin, dimethyl anthranilate, dimethyl benzylcarbinyl-butyrate, dimethyl sulfide nat., diphenyl oxide, noble fir needle identoil, noble fir needle identoil B, oak moss resin D50342, strawberry D50026C, acetic acid nat., tarragon identoil, ethoxyfuranone, ethyl 2-methylbutyrate nat., ethyl caproate non-kosher, ethyl 2-methylbutyrate, ethyl acetate nat., ethyl acetoacetate, ethyl benzoate, ethyl butyrate, ethyl butyrate nat., ethyl caproate, ethyl caproate nat., ethyl caprylate, ethyl caprylate nat., ethyl cinnamate, ethyl formate, ethyl heptylate, ethyl isovalerate, ethyl phenylacetate, ethyl propionate, ethyl salicylate, eucalyptol, eucalyptus oil globulus BP, eugenol, eugenol methyl ether, farenal, fennel oil, techn., Feuilles de Tomate 79569PM, spruce green 8001S, spruce needle identoil B sib., spruce needle identoil sib., filbertone G, fir balsam DM, Fleur de Cassis SBU PM, floropal, florophyll 10183, fragolane, framboson 10583F, frutinate, galbanum synthessence, galbanum synthresin B, geranium identoil African, geranium identoil bourbon, geranyl tiglate, globalide 100%, globanone 50% DEP, globanone 50% DPG, globanone 50% IPM, grapefruit D50075N, grapefruit identoil D61286G, green honey melon D50315, guava 10875N, helichrysum synthessence, herbaflorat, hexyl acetate, hexyl acetate nat., hexyl salicylate, hydrocitronitrile, Indian Spice 10898, indoflor H&R cryst., indole FF, ginger oil spec. D40393S, ionone pure 100%, iris synthresin H&R, irolene P, isoamyl acetate G, isoamyl acetate nat., isoamyl butyrate, isoamyl butyrate nat., isoamyl isobutyrate nat., isoamyl isovalerate, isoananate, isobornyl acetate, isobutyric acid nat., isobutyl acetate nat., isobutylquinoline, isobutylquinoline 54, isoeugenol methyl ether, isotabac naturelle LN DB10038, jasmaprunat, camomile identoil blue, camomile Rom. synthessence, pine needle identoil, pine needle identoil B, pine needle identoil B P, kiwi D50195PM, cresol methyl ether para, lactojasmone, lavandin identoil 30/32%, lavandin identoil French type 30/32%, lavandin provence D50817, lavender identoil type Mt. Blanc 40/42%, lavender oil type Mt. Blanc 40/42%, leguminal, limonene d pure, loganberry D50398N PM, bayleaf oil D50286, mace oil extra, Macrolide®, Macrolide® supra, mandranol, magnolan, majantol, mandaril, manderine synthessence, mango D50436PM, maracuja D50042E PM, marjoliane N DB10018, mayciane N DB10023, melissa identoil German so-called, menthol D dist., menthol liquid, menthol rac., menthol rac. PH, menthol-1 dist., menthol-1 H&R compacted, menthol oil, menthone-1/-isomenthone-d, 1-menthyl acetate, metaxa D50247C, 2,3-methylethylpyrazine, methyl 2-methylbutyrate, methylacetophenone para, methyl anthranilate, methyl benzoate H&R, methyl benzoate techn. pure, methyl betanaphthyl ketone cryst., 2-methylbutyric acid nat., methyl cinnamate, methyl phenylacetate, methyl salicylate, methylcinnamaldehyde alpha, Miel Blanc N DB 10024, musk seed synthessence, mugetanol, mugofleur D50444PM, clary sage identoil, clary sage identoil B, clove blossom identoil, clove leaf identoil dark, clove leaf oil decol., neononyl acetate, neroli identoil, nerolin yara yara cryst., neroli oil 4663, olibanum synthresin, orange identoil TSA, orange oil spec. D40393P, origanum identoil, oryclon extra, oryclon special, osmanthia 353, ozonil, palisandal, palisandin, palmarosa synthessence, pastinak synthessence, patchouli synthessence N, patchouli oil decol. DM, pear D50313A PM, Peru balsam identoil, Peru balsam synth. H&R, petitgrain bigarade synthessence, petitgrain identoil R, peach D40110PM, plum D50424, phenirat, phenoxyethyl alcohol/arosol, phenylacetaldehyde 100%, phenylacetaldehyde dimethyl acetal, phenylethyl acetate, phenylethyl alcohol pure, phenylethyl cinnamate cryst., phenylethyl isobutyrate, phenylethylphenyl acetate, phenylpropyl alcohol, pimento identoil, Poivre Coeur H&R PM, Poivron N DB10029, prenyl acetate, prenyl salicylate, profarnesal, projasmone P, propionic acid nat., propyl acetate nat., prunol N DB10027, pyroprunat, rain forest D50339C PM, resedafol, rosaphen, rose booster D50221A, rose F50048R PG, rosemary identoil, rosemary identoil Spanish, rosewood bras. identoil, sage identoil Span., sage identoil Span., sandalwood S.E.A. D50820, sandel 80, sandel extra, sandel forte, sandel H&R, sandel H&R super, sandel SP, sandel type east Ind., sandelwood type east Ind., sandolen H&R, spike identoil, styrax identoil D50186, styrollyl acetate, sweet amber D50807, tobacco aroma H&R D50799, teatree D50780A, thyme identoil, thyme red identoil, thyme synthabsolue, thymol dist., thymol cryst. H&R, tonca synthresin, vanillin nat., verbena identoil type French, verdeflora D50375D, verdural F, vertocitral, vertocitral C, vertosine, vetiver identoil J, juniperberry identoil 10900, juniper berry synthessence, willow scent 6103CB HG, wintergreen oil, ylang 10372 MT, ylang ylang identoil bourbon I, ylang ylang identoil bourbon II, ylang ylang identoil bourbon III, cinnamaldehyde, cinnamaldehyde nat., cinnamyl alcohol, cinnamon leaf identoil and/or cinnamon bark identoil.

It goes without saying that fragrance compositions according to the invention can comprise, in particular as scents, also compounds which are suitable as aroma, scent or fragrance, or as solid or liquid matrix material, which are supplied by other manufacturers or occur in nature.

Besides the abovementioned components, it may be advantageous if the composition according to the invention has further additives, such as, for example, emulsion auxiliaries, preservatives or the like.

The fragrance composition according to the invention is preferably prepared by the method according to the invention. This is notable for the fact that, for the preparation of a fragrance composition according to the invention, at least one fragrance/scent or base oil is intensively mixed with at least one ionic liquid. It may be advantageous if the fragrance and/or the ionic liquid is mixed with a solid or liquid matrix material and/or an additive prior to the intensive mixing.

Base oils, which in most cases consist of more than one scent component, are usually mixed cold at room temperature by cold-mixing operations in order to avoid undesired secondary reactions with the scents. This base oil can be mixed directly with the ionic liquid. The mixing of base oil and ionic liquids also preferably takes place by cold-mixing operations at room temperature or maximum temperatures of up to 35° C. If one of the components, i.e. a scent or an ionic liquid, is in the form of a solid, then these are preferably firstly dissolved in a solvent, if necessary at elevated temperature, and, after cooling, mixed with the liquid scents or the base oil, which may, if appropriate, already have ionic liquids.

In the case of substances of low miscibility or high viscosity, it may be advantageous to use stirrer systems with high shear forces (rotor stator systems, such as, for example, Turrax systems). If solids are to be mixed in, then these are initially introduced together with the liquids and then mixed in a suitable dispersing unit.

The fragrance composition according to the invention can be used as perfume, soap additive, deodorant additive and the like. In particular, the fragrance compositions according to the invention can be used to produce perfumes, soaps, deodorants, hair-treatment compositions, bodycare compositions, detergents and cleaners, household articles, room air fresheners and room sprays, foods and luxury products, essences and seasoning constituents, smoking agents. Through the fragrance compositions according to the invention, products are accessible, in particular the abovementioned products of daily need, which have these compositions. Such products may, for example, be fine perfumes, bodycare compositions, toiletries, detergent perfumes, fabric softener perfumes or scents for masking industrial odors.

### EXAMPLES

Three fragrance compositions were prepared according to the formulations described in examples 1-3, in each case with (I) and without (Ia) fixative:

Example 1

| I | Ia | Chypre note |
|---|---|---|
| 300 | 300 | Bergamot oil |
| 80 | 80 | Mousee de Chène absol. |
| 60 | 60 | Ylang ylang |
| 15 | 15 | Jasmine absol. |
| 15 | 15 | Rose de Mai absol. |
| 20 | 20 | Dianthine (Firmenich) |
| 50 | 50 | Iralia |
| 60 | 60 | Irrozol |
| 35 | 35 | Propylphenylacetaldehyde |
| 15 | 15 | Vanillin |
| 70 | 70 | Vetiver oil |
| 50 | 50 | Oppononax |
| 100 | 100 | Heliotropin |
| 20 | 20 | Sandel oil O.I. |
| 40 | 40 | Patchouli oil |
| 30 | 30 | Dihydrocoumarin |
| 5 | 40 | Cyclopentadecanolide |
| 35 | 0 | 1,3-Dimethylimidazolium methylsulfate |
| 1000 | 1000 | Parts by weight |

Example 2

| I | Ia | Musk base |
|---|---|---|
| 280 | 280 | Rose synthetic |
| 80 | 80 | Rose absol. |
| 100 | 100 | Jasmine liqu. S.A. |
| 60 | 60 | Jasmine synthetic |
| 60 | 60 | Geranium oil |
| 125 | 125 | Bergamot oil |
| 25 | 25 | Patchouli oil |
| 50 | 50 | Tuberose synthetic |
| 25 | 25 | Tuberose absol. |
| 60 | 60 | Cassia oil |
| 40 | 40 | Benzoin Siam resinoid |
| 25 | 25 | Civet synthetic |
| 45 | 70 | Exaltone |
| 25 | 0 | 1-Ethyl-3-methylimidazolium tosylate |
| 1000 | 1000 | Parts by weight |

Example 3

| I | Ia | Rose composition |
|---|---|---|
| 5 | 5 | Geranium oil bourbon |
| 10 | 10 | Phenylethyl isoamyl ether |
| 20 | 20 | Phenylacetaldehyde |
| 20 | 20 | Citral |
| 30 | 30 | Dihydro rose oxide |
| 40 | 40 | Phenylethyl acetate |
| 80 | 80 | Phenylethyl alcohol |
| 50 | 50 | Geranyl acetate |
| 250 | 280 | Geraniol |
| 450 | 450 | Citronellol |
| 10 | 15 | Ethylvanillin |
| 35 | 0 | 1-Butyl-3-methylimidazolium methylsulfate |
| 1000 | 1000 | |

### Example 4

To determine the adhesive strength of the compositions, the respective compositions according to examples 1 to 3 comprising one of the ionic liquids according to the invention (working variant I) and in a comparative experiment the corresponding compositions without ionic liquid were sprayed onto a cotton fabric measuring 3×3 cm, and the adhesive strength was determined using a smell test. It was found that in the case of all of the compositions with ionic liquid a significantly greater adhesive strength was established than in the case of the corresponding compositions without ionic liquid. This means that in the case of the compositions with ionic liquid, the scent could be detected for longer than in the case of the compositions without ionic liquid.

1. A fragrance composition comprising at least one ionic liquid as a fixative.

2. The fragrance composition as claimed in claim 1, wherein the composition has 0.1% by weight to 20% by weight of ionic liquid, based on the base oil.

3. The fragrance composition as claimed in claim 1, wherein the composition has 0.5% by weight to 10% by weight of ionic liquid, based on the base oil.

4. The fragrance composition as claimed in claim 1, wherein the ionic liquid is a salt with a cation according to the following structures, 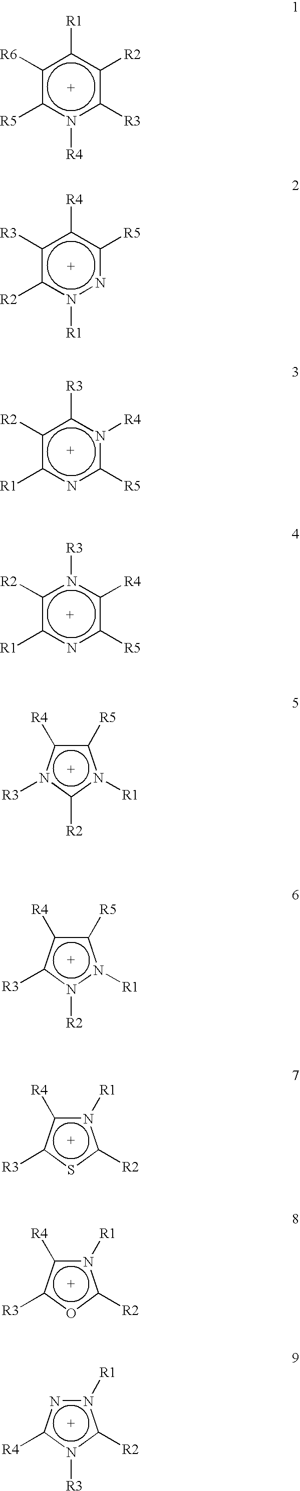 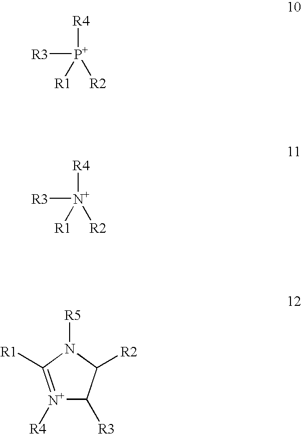
wherein R1, R2, R3, R4, R5 and R6 are identical or different and are hydrogen, a learn or branched aliphatic hydrocarbon radical having 1 to 20 carbon atoms, a cycloaliphatic hydrocarbon radical having 5 to 30 carbon atoms, an aromatic hydrocarbon radical having 6 to 30 atoms, an alkylaryl radical having 7 to 40 carbon atoms, a linear or branched aliphatic hydrocarbon radical having 2 to 20 carbon atoms which is interrupted by one or more heteroatoms (oxygen, NH, NCH₃), a linear or branched aliphatic hydrocarbon radical having 2 to 20 carbon atoms which is interrupted by one or more functionalities chosen from the group —O—C(O)—, —(O)C—O—, —NH—C(O)—, —(O)C—NH, —(CH₃)N—C(O)—, —(O)C—N(CH₃)—, —S(O)₂—O—, —O—S(O)₂—, —S(O)₂—NH—, —NH—S(O)₂—, —S(O)₂—N(CH₃)—, —N(CH₃)—S(O)₂—, a terminally —OH, —NH₂, —N(H)CH₃ functionalized linear or branched aliphatic hydrocarbon radical having 1 to 20 carbon atoms or a polyether with a blockwise or random structure according to —(R⁷—O)ₙ—R⁸, where R⁷ is a linear or branched hydrocarbon radical comprising 2 to 4 carbon atoms, n=1 to 30 and R⁸ is hydrogen, a linear or branched aliphatic hydrocarbon radical having 1 to 20 carbon atoms, a cycloaliphatic hydrocarbon radical having 5 to 30 carbon atoms, an aromatic hydrocarbon radical having 6 to 30 carbon atoms, an alkylaryl radical having 7 to 40 carbon atoms, or are a radical —C(O)—R⁹ where R⁹ is a linear or branched aliphatic hydrocarbon radical having 1 to 20 carbon atoms, a cycloaliphatic hydrocarbon radical having 5 to 30 carbon atoms, an aromatic hydrocarbon radical having 6 to 30 carbon atoms, an alkylaryl radical having 7 to 40 carbon atoms; and an anion selected from the group consisting of halide, phosphate, halophosphates, alkylphosphates, nitrate, sulfate, hydrogensulfate, alkylsulfates, arylsulfates, perfluorinated alkyl- and arylsulfates, sulfonate, alkylsulfonates, arylsulfonates, perfluorinated alkyl- and arylsulfonates, perchlorate, tetrachloroaluminate, tetrafluoroborate, alkylborates, tosylate, saccharinate, alkylcarboxylates and bis(perfluoroalkylsulfonyl)amide anions; or is a mixture of two or more such salts.

5. The fragrance composition as claimed in claim 1, wherein the ionic liquid used is a salt with a cation selected from the group consisting of imidazolium ion, pyridinium ion, ammonium ion and phosphonium ion according to the following structures: 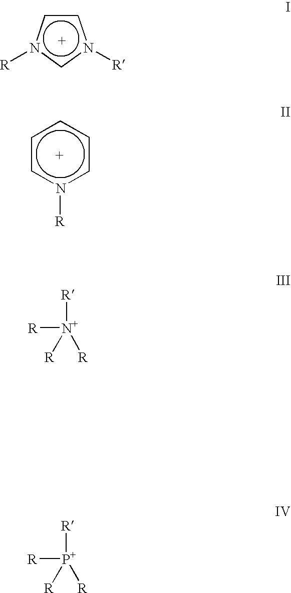
wherein R and R′ are H, identical or different substituted or unsubstituted alkyl, olefin or aryl groups wherein R and R′ have identical or different meanings.

6. The fragrance composition as claimed in claim 1, wherein the ionic liquid has a halogen-free anion selected from the group consisting of phosphate, alkylphosphates, nitrate, sulfate, alkylsulfates, arylsulfates, sulfonate, alkylsulfonates, arylsulfonates, alkylborates, tosylate, saccharinate and alkylcarboxylates.

7. The fragrance composition as claimed in claim 1, wherein the ionic liquid of the fragrance composition has one or more anions.

8. The fragrance composition as claimed in claim 1, wherein the fragrance composition has microbicidal properties.

9. The fragrance composition as claimed in claim 1, further comprising fixatives chosen from self-fixatives, pseudofixatives, stimulants and/or “true” fixatives, besides at least one ionic liquid.

10. The fragrance composition as claimed in claim 1, further comprising an alcohol as solvent.

11. The fragrance composition as claimed in claim 1, further comprising, as fragrance, a natural, nature-identical, semisynthetic and/or completely synthetic fragrance.

12. The fragrance composition as claimed in claim 1, further comprising a preservative.

13. A method of producing a fragrance composition as claimed in claim 1, wherein at least one fragrance is mixed intensively with at least one ionic liquid.

14. The method as claimed in claim 13, wherein the mixing of fragrance and ionic liquid takes place cold at room temperature.

15. (canceled)

16. A product comprising said fragrance composition as claimed in claim 1.

17. The product as claimed in claim 16, wherein the product is a fine perfume, bodycare composition, toiletry, detergent perfume, fabric softener perfume or a scent to mask industrial odors.
